(19) United States
(12) Patent Application Publication
(10) Pub. No.: US 2022/0258424 A1
(43) Pub. Date: Aug. 18, 2022

(54) ADDITIVE MANUFACTURING MACHINES FOR THE ADDITIVE MANUFACTURING OF AN OBJECT LAYER-BY-LAYER

(71) Applicant: ATUM HOLDING B.V., GOUDA (NL)

(72) Inventors: Tristram BUDEL, GOUDA (NL); Ramon Rudolf TETTEROO, DEN HAAG (NL); Chanil BUDEL, HOORN (NL)

(73) Assignee: ATUM HOLDING B.V., GOUDA (NL)

(21) Appl. No.: 17/605,053

(22) PCT Filed: Feb. 28, 2020
(86) PCT No.: PCT/NL2020/050133

§ 371 Date: Oct. 20, 2021

(30) Foreign Application Priority Data
May 2, 2019 (NL) 2023055

(51) Int. Cl. B29C 64/277; B33Y 10/00; B33Y 30/00; B29C 64/135; B29C 64/236

(52) U.S. Cl. CPC B29C 64/277; B33Y 10/00; B29C 64/236; B29C 64/135; B33Y 30/00

(57) ABSTRACT

A 3D additive manufacturing machine and an additive manufacturing method for manufacturing objects layer by layer, to obviate a need for a rotating prism. The machine can fill spaces in any one layer between paths generated by neighboring illumination spots from an array by sweeping subsequent paths between previously manufactured paths or by meandering along the paths. As a consequence, sufficient intensity may be provided for 3D additive manufacturing, even when using LEDs as a light sources.

### FIELD OF INVENTION

The present invention relates to manufacturing machines for the additive manufacturing of three dimensional objects from additive manufacturing material, layer-by-layer, with increased manufacturing quality, in particular additive manufacturing machines without complicated optics.

### BACKGROUND

Additive Manufacturing (AM), also known as 3D printing, refers to technologies of building 3D objects by adding layers upon layers of material, whether the material is liquid, powder, sheet material or other.

Several known processes for 3D printing use a high energy source for building layers. Among those processes are known in particular stereo lithography (SLA), Digital Light Processing (DLP), Selective Laser Sintering (SLS), Direct Metal Laser Sintering (DMLS) and Selective Laser meting (SLM).

Prior art printers use lasers as high energy illumination sources. These systems often comprise an array of lasers in combination with a constantly rotating precision optical prism smearing the laser beam between sources. These prior art techniques are disclosed in FIGS. 1A-1D. FIG. 1A illustrates a laser 10 directed at a prism 20 in a first position and deviating the laser beam to a spot 30 due to its geometry and the incidence angle of the laser on its surface. When rotating the prism 20, FIGS. 1B and 1C illustrate how the incidence angle changes and how the location of the beam output changes accordingly. In FIG. 1D, ends and middle positions 40 of the beam output during the rotation of the prism are shown. One multifaceted prism may be used for a whole array of sources in order to displace the laser beams and cover the gap between the illumination sources. A translation of the whole assembly comprising the lasers and the prism further covers the whole working area. The manufacture and operation of the rotating optical prism is however costly, complicated and limits the precision and printing quality.

### SUMMARY

The object of the invention is to provide an additive manufacturing machine for the additive manufacturing an object on a working area layer-by-layer overcoming said prior art shortcomings.

According to a first aspect of the invention, there is provided an additive manufacturing machine configured to manufacture an object from additive manufacturing material on a working area, layer-after-layer in a plurality of layers, comprising an array of focused illumination sources with spacing between the illumination sources in the array, wherein the illumination sources, when actuated, focus sufficient energy in each of an array of illumination spots to manufacture the additive manufacturing material in one of the layers of the additive manufacturing material at a time and a mover, carrying the illumination sources or the working area, wherein, when the mover is actuated, the illumination spots form elongate manufactured paths in the one of the layers, with the paths having a width corresponding to a size of the spots. The additive manufacturing machine is configured such that at least one of the mover and the illumination sources is configured to displace the illumination spots within the one of the layers sideways relative to the paths over a smaller distance than the spacing.

According to a second aspect of the invention, there is provided an additive manufacturing machine configured to manufacture an object from additive manufacturing material on a working area, layer-after-layer in a plurality of layers, comprising an array of focused illumination sources, wherein the illumination sources, when actuated, focus sufficient energy in each of an array of illumination spots to manufacture the additive manufacturing material in one of the layers of the additive manufacturing material at a time and a mover, carrying the illumination sources or the working area, wherein, when the mover is actuated, the illumination spots form elongate manufactured paths in the one of the layers, with the paths having a width corresponding to a size of the spots. The additive manufacturing machine is configured such that the array comprises at least two essentially parallel rows of focused illumination sources with a spacing between the illumination sources in each row, and the rows are offset relative to each other in a staggered manner over a smaller distance than the spacing, wherein paths formed by the illumination sources in one of the rows are manufactured between paths formed by the illumination sources in at least one of the other rows. Alternatively the array may comprise at least two essentially parallel columns of focused illumination sources with a spacing between the illumination sources in each column, and the rows are offset relative to each other in a staggered manner over a smaller distance than the spacing, wherein paths formed by the illumination sources in one of the columns are manufactured between paths formed by the illumination sources in at least one of the other columns.

According to a preferred embodiment according to the second aspect of the invention, at least one of the mover and the illumination sources is configured to displace the array of illumination spots sideways relative to the paths over a smaller distance than the spacing.

According to a preferred embodiment, the mover is configured to translate the array of sources or the working area, sideways relative to the paths.

According to a preferred embodiment, the mover is configured to tilt at least one source or the optical system of at least one source sideways relative to the paths.

According to a preferred embodiment, the sideways displacement is done prior to having a subsequent sweep of the work area to form further elongate manufactured paths. Alternatively, the sideways displacement is done during a sweep of the mover.

According to a preferred embodiment, the displacement amount is related to the spot size and optionally to an overlap between sweeps to have adjacent paths of illumination spots.

According to a preferred embodiment, the spacing between sources divided by the spot size determines the number of sweeps.

According to a preferred embodiment, subsequent sweeps overlap. Preferably the spacing between sources divided by the spot size minus the overlap determines the number of sweeps.

According to a preferred embodiment, a single spot is used with simultaneous movements in both x and y axis to trace the contour of the layer. Alternatively, multiple spots are used simultaneously with movements in both x and y axis to trace the contour of the layer.

According to a preferred embodiment, the focused illumination sources comprise focusing optics. The focusing optics may be configured to change the spot size to cover partially or totally the distance between paths of neighboring sources. Preferably, the focusing optics comprise at least a first lens (125) to focus the energy of the illumination source to a given spot size. Preferably the focusing optics comprise a pinhole and the at least first lens is after the pinhole to focus the contour of the pinhole leading to a fine point with a given spot size. More preferably, the focusing optics comprise a second lens prior to a pinhole. Preferably, the second lens has a short focal distance to couple more light in to the pinhole.

According to a preferred embodiment, each spot of each source can be independently displaced or modified. Similarly preferably the intensity of each source can be independently dimmed. According to a preferred embodiment, the illumination sources are the same or different in intensity, wavelength and spot size.

According to a preferred embodiment, several sources are focused on the same spot.

According to a preferred embodiment, the sources are LEDs or Laser diodes.

According to a preferred embodiment, the sources are arranged in rows and columns. Preferably the rows and columns of the array of sources are arranged essentially obliquely relative to the direction of the mover defining the manufactured paths.

According to a preferred embodiment, a sensor is provided for mapping the spot location and a microprocessor for analyzing inaccuracies and feeding back corrections to the mover or the actuator.

According to a preferred embodiment, the mover is able to move in 3D.

According to another embodiment, there is provided a method for additive manufacturing, with an additive manufacturing machine according to the first aspect of the invention, an object from additive manufacturing material on a working area, layer-after-layer in a plurality of layers, comprising:
actuating an array of focused illumination sources with spacing between the illumination sources in the array, wherein the illumination sources, when actuated, focus sufficient energy in each of an array of illumination spots to manufacture the additive manufacturing material in one of the layers of the additive manufacturing material at a time; and
moving a mover, carrying the illumination sources or the working area, wherein, when the mover is actuated, the illumination spots form elongate manufactured paths in the one of the layers, with the paths having a width corresponding to a size of the spots;
displacing the illumination spots within the one of the layers sideways relative to the paths over a smaller distance than the spacing.

According to the second aspect of the invention, there is provided a method for additive manufacturing, with an additive manufacturing machine according to the second embodiment, an object from additive manufacturing material on a working area, layer-after-layer in a plurality of layers comprising:
actuating an array of focused illumination sources, wherein the illumination sources, when actuated, focus sufficient energy in each of an array of illumination spots to manufacture the additive manufacturing material in one of the layers of the additive manufacturing material at a time; and
moving a mover, carrying the illumination sources or the working area, wherein, when the mover is actuated, the illumination spots form elongate manufactured paths in the one of the layers, with the paths having a width corresponding to a size of the spots, wherein the array comprises at least two parallel rows of focused illumination sources with a spacing between the illumination sources in each row, wherein the rows are offset relative to each other in a staggered manner over a smaller distance than the spacing,
obtaining manufactured paths formed by the illumination sources in one of the rows between paths formed by the illumination sources in at least one of the other rows.

### BRIEF DESCRIPTION OF THE FIGURES

This and other aspects of the present invention will now be described in more detail, with reference to the appended drawings showing currently preferred embodiments of the invention. Like numbers refer to like features throughout the drawings.

FIGS. 1A-1D show a prior art solution using a laser and a complex rotating prism.

FIG. 2 shows a functional model of a device according to the invention.

FIGS. 3 and 4 show respectively a single light source and an array of multiple light sources according to an embodiment of the invention.

FIG. 5 shows a focused illumination source according to the invention,

FIG. 6A shows an embodiment of the invention with two sources and a translation of said sources to obtain adjacent paths.

FIG. 6B shows a print obtained with the embodiment of FIG. 6A.

FIG. 7A shows another embodiment of the invention where the optical system of a source is tilted.

FIG. 7B shows another alternative embodiment of the invention where the source is tilted.

FIG. 8 shows another embodiment of the present invention with an array comprising multiple rows of radiation sources in an alternating, staggered manner.

FIG. 9 and FIG. 10 show further embodiments of the invention with multiple sources and combined spots.

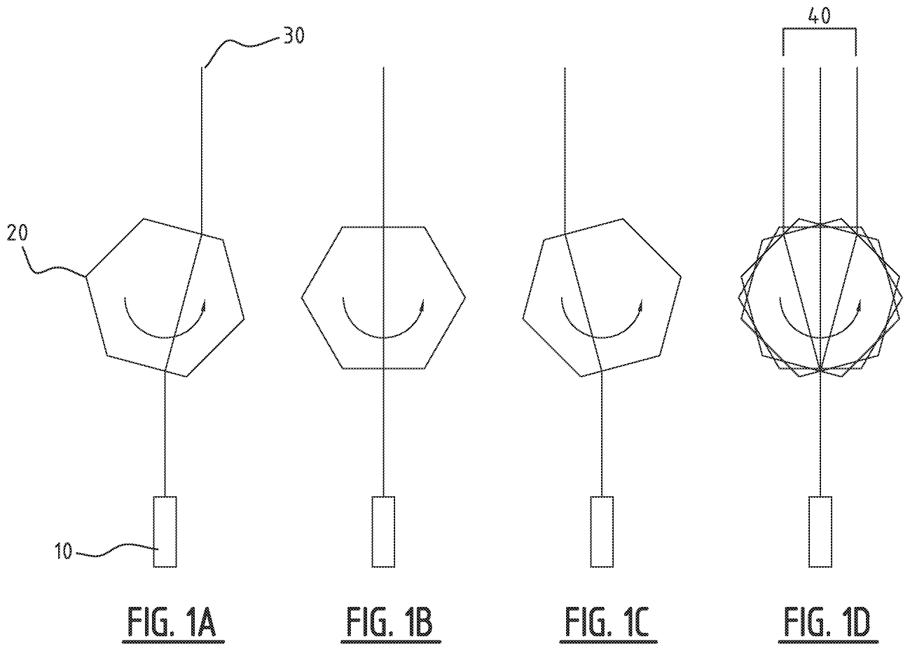

### DESCRIPTION OF EMBODIMENTS

First the system will be described in general then embodiments of the invention will be disclosed. In particular in this description, a printer for printing an object with printing material will be described as an exemplary embodiment of an additive manufacturing machine for manufacturing an object with additive manufacturing material. The terms, irradiating source, illuminating source, light source or scanning light source may be used indifferently in the rest of the description to refer to the same or similar elements. Similarly the terms a mover or a moving system may be used indifferently to refer to the same or similar elements.

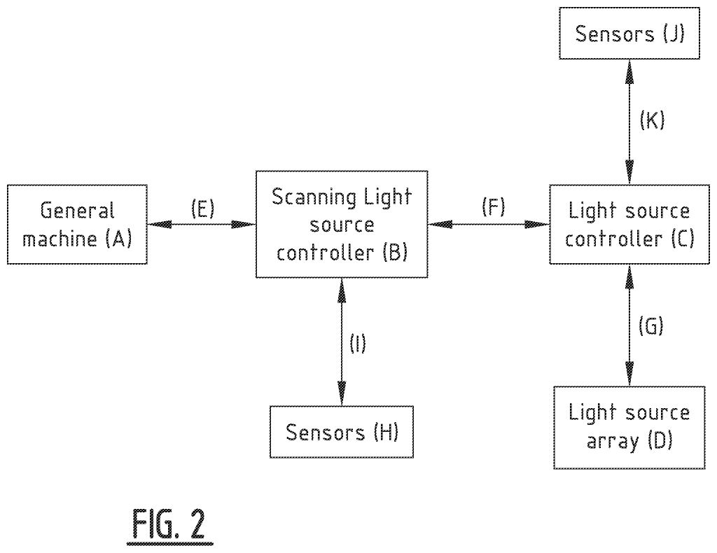

A functional model of the whole system is shown in FIG. 2. The system relates to printer configured to print an object from printing material on a working area, layer-after-layer in a plurality of layers. The system comprises an array D of focused illumination sources wherein the illumination sources, when actuated, focus sufficient energy in each of an array of illumination spots to print the printing material in one of the layers of the printing material at a time and a mover, carrying the illumination sources or the working area, wherein, when the mover is actuated, the illumination spots form elongate printed paths in the one of the layers, with the paths having a width corresponding to a size of the spots. At least one of the mover and the illumination sources is configured to displace the illumination spots within the one of the layers sideways.

In said model, A refers to a connection of the system to the rest of the printer.

B refers to a stationary control unit that receives and sends data to the rest of the printer machine. This controller controls the motors and sensors of the X, Y, Z axis mover (not represented) that moves the scanning light array. It also measures end stop information, and closed loop motor information.

C refers to a controller that drives the light array and sensors on the mover.

D refers to the light array, which when actuated, focusses sufficient energy in each of an array of illumination spots to print the printing material in one of the layers of the printing material at a time.

E refers to a data connection from the rest of the printer to the scanning light source controller. The data send can relate to the movement pattern, the movement speeds and accelerations, the light intensity, the light timing over movement. In addition a feedback is send back to rest of machine, representing information that the data was received, or the sequence was initiated, or completed as well as sensor data.

F refers to a data connection from the scanning light source controller to the light source controller. The connection allows sending light source timing data and light intensities. It receives sensor data, data received confirmation information, data executed information.

G refers to a data connection between the light source controller and light source array meant for direct control of the light source timing and the light intensity. This data connection carries measurements of light source consumption amperage, Voltage over light source, LDR input, RGB input.

H refers to sensors providing information like end stops, or motor positions. A camera can be optionally used.

I refers to the data sensed by said sensors (H), for instance End stops, camera information, or motor positions.

J refers to additional sensors sensing for example the light intensity, current, voltage, or color of the light source array.

K refers to the data by said sensors (J), for instance light intensity, current, voltage, or color. It is noted that elements C, D and J would be components physically moving with mover (not represented). Alternatively, the working area could be moved instead of the illumination sources.

The invention is described in detail for printers having an array of sources, i.e. comprising multiple irradiation sources which represent the preferred embodiment for fast printing but the principle applies equally to a printer with a single source of irradiation.

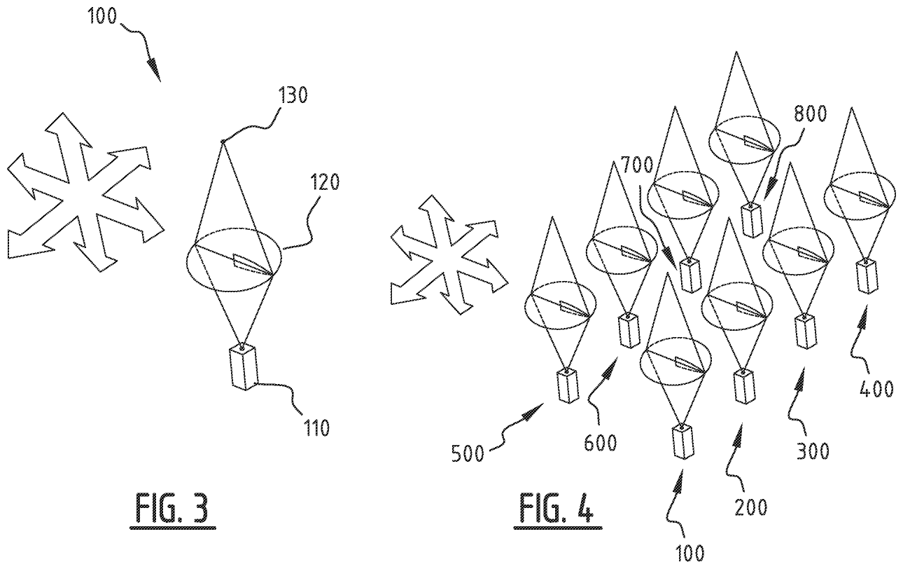

FIG. 3 illustrates a single focused light source 100, comprising an unfocused source and an optical system 120 to focus the light in to a point 130, to form a light spot. This focused light source is mounted on a mover (not represented) able to displace said source in 3 dimensions, i.e. according to x, y, z, axes. Alternatively the mover could displace the working area on which the product is being build layers by layers, instead of the source.

FIG. 4 illustrates a light source array comprising two or more focused light sources 100 till 800, each with an unfocused source and an optical system or optical systems to focus the light into a point or multiple points. The sources shown in FIG. 4 are arranged in two rows of four sources each (100-400, 500-800) and four columns of two sources each. The array is mounted on a mover (not represented) able to displace said array in 3 dimensions, i.e. according to x, y, z, axes. Alternatively the mover could displace the working area on which the product is being build layers by layers, instead of the array.

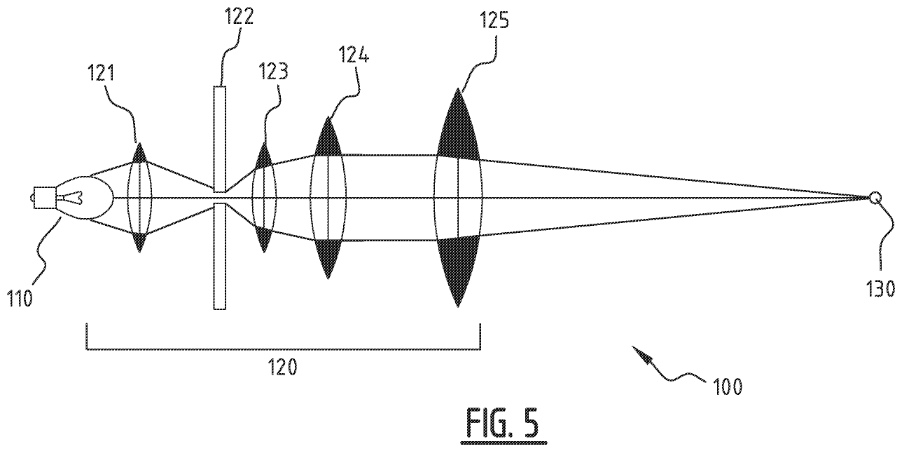

FIG. 5 shows a schematic representation of a focused illumination source comprising focusing optics according to the invention. Each focused illumination source 100 comprises an unfocused light source 110, in practice a LED source, equipped with focusing optics 120. The focusing optics 120 comprise a pinhole 122 and at least a first lens 125 after the pinhole to focus the contour of the pinhole leading to a light beam creating a fine point with a given spot size. The focusing optics may comprise further a second lens 121 prior to a pinhole 122. The second lens 121 has a short focal distance to couple more light in to the pinhole 122. The shown optical arrangement 120 using micro lenses, 121, 123, 124 and 125 enables the entire lens stack to only be 5 cm tall. The present optical system increases the light output of the system by a factor of 25 compared to an optical arrangement without the lens 121 prior to a pinhole 122.

Larger spot sizes may be created by forgoing the use of a pinhole in the focusing optics.

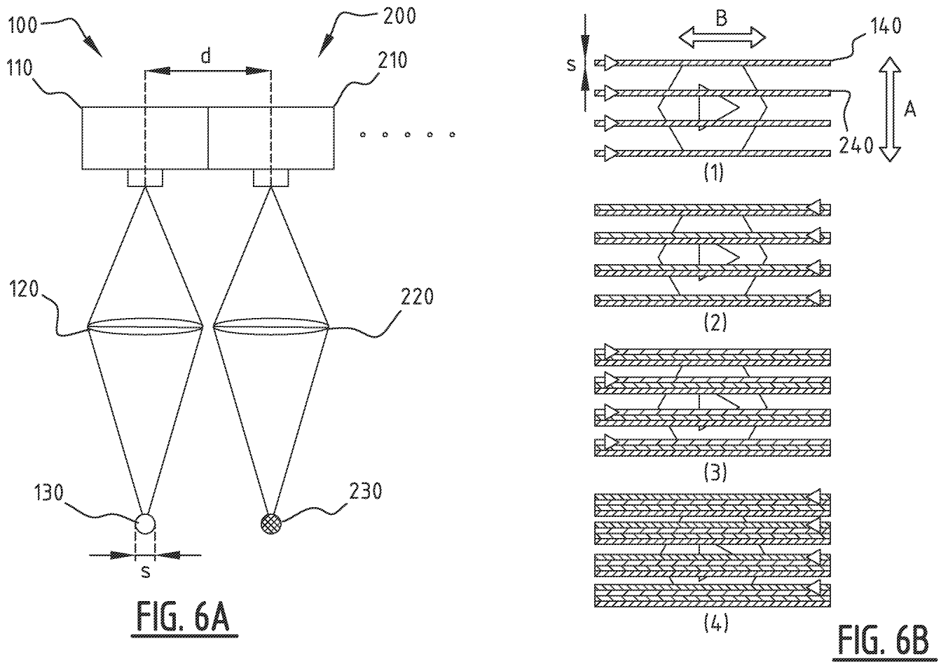

FIG. 6A shows a first embodiment with an array of at least two focused illumination sources 100 and 200, each according to FIG. 5. The two unfocused sources 110 and 120 of each focused source 100 and 200 are spaced apart by a spacing distance d represented in FIG. 6A. The unfocused sources 110, 210, when actuated, in combination with their focusing optics focus sufficient energy in each of an array of illumination spots 130, 230 to print the printing material in one of the layers of the printing material at a time. A spot size s is represented in FIG. 6A. The two sources are represented as having the same spot size. Alternatively the spot sizes for different sources may be different.

In addition, although not represented, a mover is provided for carrying the illumination sources 100 and 200 or the working area.

FIG. 6B illustrates how the mover displaces the illumination spots in a biaxial system. When the mover is actuated, the illumination spots 130 and 230 form elongate printed paths 140, 240 in the one of the layers along the B direction. The paths 140 and 240 have a width corresponding to a size s of the spots 130, 230.

At least one of the mover and the illumination sources 100, 200 is configured to displace the illumination spots 130, 230 within the one of the layers sideways relative to the paths 140, 240, i.e. along the A direction over a smaller distance than the spacing d between the sources. In this manner adjacent printed paths can be obtained as illustrated in FIG. 6B.

Said array may comprise multiple irradiation sources placed for instance in rows and columns. It is particularly noted that in case of multiple sources the spacing d between the irradiation sources relative to each other perpendicular to the direction of travel, the B direction, i.e. along the direction A, divided by the spot size s, will determine how many scan passes are required in order to “color in” the entire surface.

In practice a preferred embodiment is a single PCB, with an array of low cost identical LED's in the appropriate wavelength, each mounted with its own focusing optic to focus the light coming out of the led in to a point. This array is mounted on an x, y system, also labelled B, A, controlled with off the shelf stepper motors and electronics.

The area is first scanned in for example the B direction, as shown in FIG. 6B (1). Then the array is shifted by an increment in the A direction and again the array travels the length of or along the B axis, as illustrated in FIG. 6B(2). Of course if the print is not the full area of the total print area then the travel along the B direction can be shorter.

In FIG. 6B (1), the first pass is performed and comprises four elongated paths 140, 240, 340 and 440 for the four sources and then followed by a shift in the A direction for the second pass in FIG. 6B(2) (in the opposite direction as the first pass), then the third pass in FIG. 6B (3), and the fourth pass in FIG. 6B (4). This process can be repeated until the entire print area is covered. During the travel the radiation source would only be switched on when the spot intersects with the cross section of the model that is being manufactured. In FIG. 6B(1), the sideways displacement along the A direction is done prior to having a subsequent sweep of the work area to form further elongate printed paths. Alternatively, the sideways displacement may be done during a sweep of the mover.

To increase resolution and printing accuracy, instead of laying each pass next to the previous pass, there can be an overlap. For example, a spot size with for example a diameter of 1 mm could be used, but as the accuracy of the layer will be determined by the mechanical axis system the final part can have the accuracy of the axis system being used, even though the minimum feature size can never be smaller than the spot size.

Specifically for stereo-lithography applications and selective sintering the option of overlapping passes might not apply to such an extent. When running passes, with or without overlap the dosage received is of key importance because the doses usually determine the layer thickness that is formed in the resin. The dosage is, exposure time times intensity D=T*W.

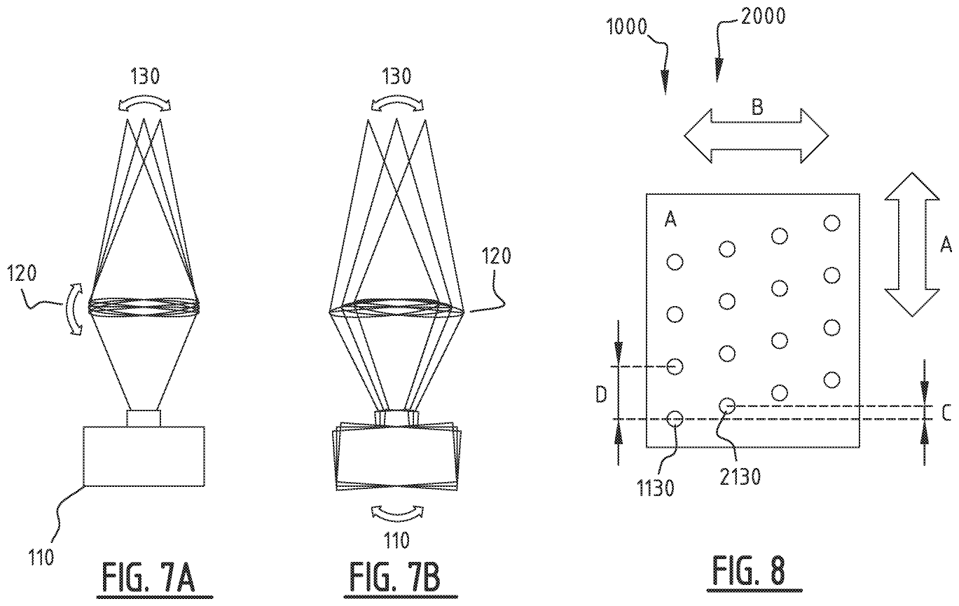

FIGS. 7A and 7B show the principle behind another embodiment of the invention, where a source or its optical system is tilted such that that spots of said source in different passes of the mover along the B direction are adjacent to each other or so that the distance between paths of neighboring sources is covered.

Two methods can be used to control the individual position of each focal point 130, by actuating/oscillating either the entire irradiation module 100 or the optics 120 of the irradiation module 100, as shown in FIGS. 7A and 7B. Both can be controlled on several axes, to sub-micron accuracies leading to an increased efficiency and accuracy of the system.

In FIG. 7A, an example is shown of actuating the optical system 120. In FIG. 7B, actuating the entire irradiation module 100 is shown. The irradiation source 100 can be actuated, displaced once upon setting up the machine or actively during printing. In practice the tilting of the source corresponds to a displacement of the spot location along the A direction. This sideways displacement along the A direction is done preferably during a pass of the mover along the B direction to form zigzag printed paths by combination of the movements in the two directions A and B. Alternatively, the sideways displacement may be done prior to having a subsequent pass of the work area along the B direction to form straight printed paths.

In addition to oscillating/tilting the sources or their optical system, if needed the mover may translate the single source or the array of sources as disclosed for the previous embodiments along the A axis as in order for the following pass to be made adjacent to a previous pass. Said passes may be repeated as often as necessary to cover the entire working area. The embodiments of FIGS. 7A and 7B may, where possible, be combined with the other embodiments described above or below.

A further embodiment of the invention is disclosed in FIG. 8 showing multiple rows of illumination sources in an alternating, staggered manner such that the relative distance between focused spots can be further reduced. FIG. 8 relates to a printer configured to print an object from printing material on a working area, layer-after-layer in a plurality of layers, comprising an array of at least two focused illumination sources 1100, 2100. The t least two illumination sources 1100, 2100 when actuated, focus sufficient energy in each of an array of illumination spots 1130, 2130 to print the printing material in one of the layers of the printing material at a time. In addition is provided a mover, not represented, carrying the illumination sources 1100, 2100 or the working area. When the mover is actuated, the illumination spots form elongate printed paths 1140, 2140 in the one of the layers, with the paths 1140, 2140 having a width corresponding to a size s of the spots 1130, 2130.

The array comprises at least two essentially parallel rows 1000, 2000 of focused illumination sources 1130, 1230, 2130, 2230 with a spacing D between the illumination sources in each row.

The rows 1000, 2000 are offset relative to each other in a staggered manner over a smaller distance C than the spacing D. The paths formed by the illumination sources in one of the rows are printed between paths formed by the illumination sources in at least one of the other rows. The path 2140 of the first source of the second row 2000 is formed in between the paths 1140 and 1240 of the first and second sources of the first row 1000. In this manner adjacent paths can be obtained and/or the relative distance between focused spots can be further reduced.

In FIG. 8, A represents the secondary scan direction. B represents the primary scan direction and C is the relative distance between paths of neighboring sources of different rows. This arrangement of the array further contributes to solving the issue of covering the whole working area and where possible may be combined with the other embodiments described above and below.

In another embodiment the focal points may be widened relative to prior art configurations, for example using replacement inherent/integrated optics in or of LED's or additional optics (if inherent LED optics tend to converge light beams) to diverge a light beam or to generate a parallel light beam to have a focal point size at the construction surface to cover a distance between paths of neighboring LED's. Such an embodiment could obviate a need for multiple passes, for “filling in” spaces/distances between paths of neighboring LED's with small focal points, relative to the mounting size of the LED's, or as an alternative for the oblique or angled arrangement of the array of LED's relative to the movement paths of focal points from the LED's. In fact, inherent/integrated optics or additional optics may be embodied to have/exhibit a variable zoom property, whereby a control over the zoom property may be provided as well, to adapt focal point sizes commonly or individually and thereby also the illumination or irradiation pattern at the construction surface, generated thereby. Combinations are also within possibilities according to the appended claims. For example variable focal point size may be combined with a control over de angle of the array relative to the movement direction of the points, which in turn may be dependent on the amount of energy that a particular material for constructing requires for curing and/or sintering.

In other embodiments each spot of each source can be independently displaced or modified. Similarly the invention encompasses that the intensity of each source can be independently dimmed. Although represented as identical, sources may be different in intensity, wavelength and spot size.

In another embodiment, the movement pattern is optimized for the purpose of surface smoothness. For every printing layer a single spot is used to trace the exact contour of the layer before filling it in order to get rid of any pixilation of the scan direction. Alternatively, multiple spots may be used simultaneously with a more complex biaxial movement to reduce contour print/scan time.

In other words instead of only using the array to print/scan in a single direction to fill in the layer, a single spot is used with simultaneous both x and y axis movements to exactly trace the contour of the layer before/after the layer is filled in a single direction. In particular the location of the edge can be approximated based on the accuracy of the movement of the array and the statistical uncertainty of the contour self. Knowing the location of the edge of the contour to such a high degree allows then to use the edge of a spot to print inside said contour. The edge of a spot used for contouring is made to precisely coincide with the edge of the contour. This precision of the trace of the contour combined with the choice of an appropriate layer thickness contribute to a greater control of the smoothness of the surface of the final model. The layer thickness may range from a couple of microns up to several millimeters. The layer thickness is in all instances selected according to the desired quality of the surface of the final model as well as the desired production parameters. By tracing precisely the contour of each layer, it becomes possible to adhere as close as possible to a layer and avoid in this way the drawback of a fixed step between layers due to a predetermined pixel size. In this way stair stepping on the profile and possible pixilation of the objects surface are prevented.

In a further embodiment, one or more focusing optics, and/or one or more light sources, can be gimballed on an A and B axis, i.e. rotated about two orthogonal axes. In this way when contouring a layer, the light beam creating the spot can be angled to follow the slope of the model in order to avoid stair stepping.

In a further embodiment the movement pattern is optimized for structural reasons. How a layer is build up can influence the behavior of the model. If the layer is build up in a single directional fashion directional stresses, shrinkage and even directional strength may also be build in. Depending on the model geometry it may therefore not be beneficial to use a single scan direction to build up the layers and thus the model. Using a cross pattern, or diagonal patterns, or any other geometric shaped pattern may be beneficial for the structural properties of the model.

### Further Benefits and Possible Embodiments

In addition to the foregoing disclosure of embodiments of the present inventive concept, it is noted that the concept as defined in the appended claims may encompass further embodiments.

Energy Density

A further benefit of this system is that compared to DLP printing the energy density per unit area is very high although very low power light sources are used. If for example a 650 mW LED is used with a lens system to create a 50 μm spot, even with an efficiency of just 25% due to optical losses the power density would be approximately 65 W/cm2.

This power density has to be compared to the power density of a system using a state of the art DLP projector of about 8 mW/cm2. The power density for the prior art projector is this low because the projector has to expose the entire print area at once, even though the total output of the projector is >5 W. In the current state of the art of common materials this is no problem. But for the latest specialty materials this can be problematic.

Polymerization in some cases is thermally driven, using part of the chemistry in the resin to generate a temperature increase to react other components in the resin. To reach a certain temperature the resin needs be heated up faster than the resin can dissipate the thermal energy. Because the power density op the DLP system is so low this is hard to achieve if you need the entire image to cover the entire build area.

When using a high-power density another effect must be considered, ablation. Where so much heat is generated in such a short amount of time that the material starts to degrade or is ablated instead of cured.

On the issue of energy density a great benefit of this system is that a high energy density can be achieved per spot. This can be controlled by dimming the light source, as this system can use a wide arrangement of light sources this can be easily achieved.

By obtaining a much higher energy density, more materials can be cured than with low energy density systems such as DLP projectors.

A DLP projector projecting over an area of 20×10 cm as commonly used will commonly have an energy density of 8 mW/cm2. Certain resins that for example have a thermal mechanism build in will have a hard time curing in such a system because the exothermic reaction takes place so slowly that the heat is dissipated before the reaction could have benefitted from the generated heat. Unlike with this system where energy densities of >50 W/cm2 are well achievable, thus kicking of such an exothermic reaction with much greater speed creating the required energy in the system before it has a chance to dissipate.

Depending on the placement of the focal cone, the location of curing in the z direction could be controlled as the energy density varies greatly over the distance from the light source.

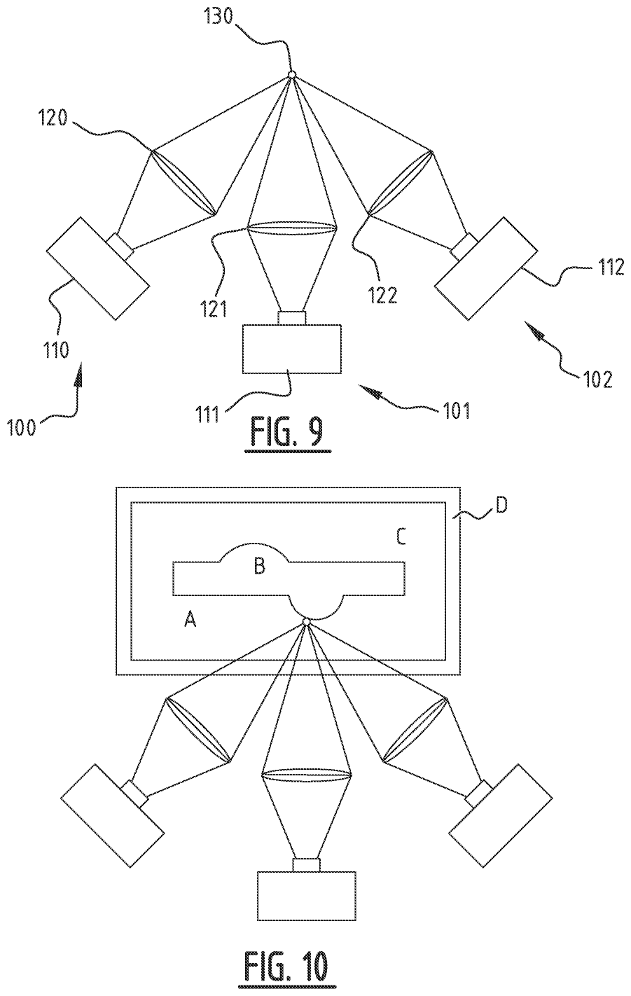

By using a large transient in energy density by either using a large focal angle or by intersecting the focal points of two or more irradiation sources of one or more frequencies a large scale multi-photon system can be used, as shown in FIG. 9 being an additional embodiment of the invention.

In FIG. 9, three unfocused sources 101, 102 and 103, with separate unfocused sources 110, 111, 112 and focusing optics 120, 121, 122 are oriented such that their focal points intersects as one spot130.

As a further alternative style of additive manufacturing, it is foreseen that the scan head can travel around an object, or that an object rotates in front of the scan head.

A layer of material can be polymerized around an existing object. According to the teachings of the present invention, polymerization inhibition can be used to achieve selective curing determined by the power density. This large step in power density could be achieved by widening the beam angle, intersection of two or more spots or a combination of the two.

For instance in FIG. 10, an embodiment of the invention is presented where multiple sources are oriented so that their spots are combined.

A refers to a point where the energy density is high enough to achieve polymerization (or melting).

B refers to an object that needs to be imbedded in to the precursor material.

C refers to a precursor material.

D refers to a radiation transparent container.

E describes a single or combined radiation source with a specific energy density point.

With this style of manufacturing either E is moved around D or D is spun in front of E.

In order to embed the existing object, the point with high energy density is traced over the surface of B, once B is properly embedded additional features can be added to this shell. This makes this method not only suited for encapsulation but to generate full 3D objects with existing objects embedded into the object that is created in this additive method.

Because of the high definition of the high energy density spot compared to the article mentioned above which uses a different irradiation technique, namely projectors, much higher resolution and accuracies can be achieved.

Printing Speed

Ideally one would cure the entire layer with a single pass, the more passes are made the longer the print job will take. To reduce the number of necessary passes to color in the cross-section that is being manufactured, several options are here envisaged.

As a first option, a larger array can be used.

As a second option an array with a higher density of irradiation sources can be used so that the travel time can be decreased by increasing the travel velocity.

As a third option larger spot sizes can be used.

This last option unlike the mass actuation method described in the cited laser prior art is interesting in that it enables to actuate each unit individually.

Accuracy

Another issue to take into account are the inaccuracies of the manufacturing process of the sources, the lenses, the lens holders and all the other elements of the irradiation array. Those inaccuracies may lead to variations of the spot locations in both the focal plane and the x, y location.

Once the array is installed a camera can be mounted to be focused in the focal plane of the light array, preferably with a diffuse image carrier at the focal plane of the irradiation source. Using the X and Y axis all spot sizes and relative spot locations can be mapped this way and compensated for in the software. This way the inaccuracies of the entire irradiation array are compensated for and become irrelevant.

The present invention offers vast benefits in the area of accuracy, as in the current state of the art a mechanical axis can give submicron accuracies on a large working area. Especially when using closed loop systems with specialty readout systems. Producing a system with an axis precision of 1 μm is a common feature which any relevant CNC machine producer can achieve. With the system according to the present invention the tolerances of the mechanical axis define the accuracy. Compared to the case of a traditional DLP printer with an accuracy of plus/minus <50 μm, accuracies of plus minus <2 μm were measured. With this system, an accuracy of more than an order of magnitude higher than the prior art system are therefore achieved.

This systems accuracy will further be determined by the following factors;

How well the position of each focal point is determined in the x,y position in relation to the other focal points of the irradiation sources in the array. This point has been described above.

How well the position of the focal point is set in the z direction, ideally this would be exactly in the curing plane. But it can be compensated for using software.

How well the doses can be controlled, the light intensity per spot must be controlled.

How well the on/off irradiation sources can be timed with the movement, this is determined by the maximum switching frequency of the system.

Buildup

Although the obvious route would be to move the light in respect to print, the print can also be moved in respect to the light source.

In the above embodiments, primary attention is directed at 3D printers, but the present disclosure is not limited thereto. For example, an apparatus of the present disclosure may be configured to apply just a single layer at a construction surface, for example to selectively, locally apply a layer of photo resist in a predetermined pattern onto a copper covered substrate plate of for example glass fiber epoxy, in a production process for making a printed circuit board. After completing the photoresist layer in the predetermined pattern, uncovered copper may be etched away to leave a predetermined copper pattern on the substrate plate. The inventive concept is also applicable to 3D and/or 2D scanning systems, for example 3D scanners and 2D paper scanners.

Although mainly meant for the context of stereo lithography, naturally this novel irradiation source could be used with different frequencies to achieve different goals such as melting of material, ablation of material, activation of specific components etc.

Further Fields of Application

Additive Manufacturing Apparatus Using an Irradiation Source in a Novel Way
Using this irradiation source to irradiate top down
Using this irradiation source to irradiate bottom up
Using this irradiation source to irradiate from the side

Single Irradiation Source on Moving Axis
Actuated single irradiation source on moving axis
Single irradiation source with actuated optics on moving axis

Array of Irradiation Sources on Moving Axis
Actuated single irradiation sources placed in an array on moving axis
Single irradiation source with actuated optics placed in an array on moving axis
Manufacturing accuracy is derived from the moving axis (plural)
Tolerances in spot locations are measured and compensated for in timing and scan pattern
Different spot sizes and or colors on the same array for improved speed and accuracy
Multiple arrays with independent movement in layers with different spot sizes and or colors for improved speed and accuracy

Actuated Focused Irradiation Source
Actuation by resonating the system in its own resonant frequency
Passively actuating the system to set a precise focal location
Actively actuating the system to vary the focal depth
Passively actuating the system to control the spot size
Actively actuating the system to control the spot size
   Controlling the spot size to control print speed
   Controlling the spot size to control the energy density of the spot

Doses Controlled Single Irradiation Source (Placed in an Array, with or without Actuation)
Dimmable irradiation source
   Light intensity dependence on the model
   Light intensity dependence on the travel speed
Speed controlled irradiation source
   Travel speed depending on the model
   Travel speed depending on the required doses

Multi Axial Moving Light Source
Sequential axial movement
   Axis by axis movement to increase printing speed
   Axis by axis movement to increase printing accuracy
Simultaneous axial movement
   Movement patterns optimized according to the model geometry.
   Simultaneous axial movement to increase printing speed
   Simultaneous axial movement to increase printing accuracy
   By varying the scan direction the material properties could be influenced
   Simultaneous axial movement for smooth surface finishing

Data Transfer
Data size and speeds
Data transfer to scan head prior to executing scan line

Multi-Layer Printing Before Moving
Scanning the geometries of the layer with different light intensities
Scanning the geometries of the layer with different scan speeds
Scanning the geometries of the layer with different irradiation frequencies

Two Photon Stereo Lithography on a Practical Scale
Intersecting focal point on a x, y axis
Intersecting focal points placed in an array placed on an x, y axis.

Additive Manufacturing Around Existing Components
Intersecting focal points moving around an object
An object rotating in front of intersecting focal points
It will be apparent that diverse additional and alternative embodiments will occur to the skilled person after the foregoing disclosure of details and features of the possible embodiment shown specifically in the figures, to which the present invention is by no means limited.

1. An additive manufacturing machine configured to manufacture an object from additive manufacturing material on a working area, layer-after-layer in a plurality of layers, comprising:
an array of focused illumination sources with a spacing between the illumination sources in the array, wherein the illumination sources, when actuated, focus sufficient energy in each of an array of illumination spots to manufacture the additive manufacturing material in one of the layers of the additive manufacturing material at a time; and
a mover, carrying the illumination sources or the working area, wherein, when the mover is actuated, the illumination spots form elongate manufactured paths in the one of the layers, with the paths having a width corresponding to a size (s) of the spots;
wherein at least one of the mover and the illumination sources is configured to displace the illumination spots within the one of the layers sideways relative to the paths over a smaller distance than the spacing.

2. An additive manufacturing machine configured to manufacture an object from additive manufacturing material on a working area, layer-after-layer in a plurality of layers, comprising:
an array of focused illumination sources, wherein the illumination sources, when actuated, focus sufficient energy in each of an array of illumination spots to manufacture the additive manufacturing material in one of the layers of the additive manufacturing material at a time; and
a mover, carrying the illumination sources or the working area, wherein, when the mover is actuated, the illumination spots form elongate manufactured paths in the one of the layers, with the paths having a width corresponding to a size of the spots;
wherein the array comprises at least two essentially parallel rows (1000,2000, . . . , 4000) of focused illumination sources with a spacing between the illumination sources in each row, and
wherein the rows are offset relative to each other in a staggered manner over a smaller distance than the spacing, wherein paths formed by the illumination sources in one of the rows are printed between paths formed by the illumination sources in at least one of the other rows.

3. The additive manufacturing machine according to claim 2, wherein at least one of the mover and the illumination sources is configured to displace the array of illumination spots sideways relative to the paths over a smaller distance than the spacing.

4. The additive manufacturing machine according to claim 1, wherein the mover is configured to translate the array of sources or the working area, sideways relative to the paths.

5. The additive manufacturing machine according to claim 1, wherein the mover is configured to tilt at least one source or the optical system of at least one source, sideways relative to the paths.

6. The additive manufacturing machine according to claim 1, wherein the sideways displacement is done prior to having a subsequent sweep of the work area to form further elongate manufactured paths.

7. The additive manufacturing machine according to claim 4, wherein the sideways displacement is done during a sweep of the mover.

8. The additive manufacturing machine according to claim 1, wherein the displacement amount is related to the spot size and optionally to an overlap between sweeps to have adjacent paths of illumination spots.

9. The additive manufacturing machine according to claim 1, wherein the spacing between sources divided by the spot size determines the number of sweeps.

10. The additive manufacturing machine according to claim 1, where subsequent sweeps overlap.

11. The additive manufacturing machine according to claim 1, wherein the spacing between sources divided by the spot size minus the overlap determines the number of sweeps.

12. The additive manufacturing machine according to claim 1, wherein a single spot is used with simultaneous movements in both x and y axis to trace the contour of the layer.

13. The additive manufacturing machine according to claim 1, wherein multiple spots are used simultaneously with movements in both x and y axis to trace the contour of the layer.

14. The additive manufacturing machine according to claim 1, wherein the focused illumination sources comprise focusing optics.

15. The additive manufacturing machine according to claim 14, wherein the focusing optics are configured to change the spot size to cover partially or totally the distance between paths of neighboring sources.

16. The additive manufacturing machine according to claim 14, wherein the focusing optics comprise at least a first lens to focus the energy of the illumination source to a given spot size.

17. The additive manufacturing machine according to claim 16, wherein the focusing optics further comprise a pinhole and the at least first lens is after the pinhole to focus the contour of the pinhole leading to a fine point with a given spot size.

18. The additive manufacturing machine according to claim 17, wherein the focusing optics comprise a second lens prior to the pinhole.

19. The additive manufacturing machine according to claim 18, wherein the second lens has a short focal distance to couple more light in to the pinhole.

20. The additive manufacturing machine according to claim 1, wherein each spot of each source can be independently displaced or modified.

21. The additive manufacturing machine according to claim 1, wherein the intensity of each source can be independently dimmed.

22. The additive manufacturing machine according to claim 1, said sources being the same or different in intensity, wavelength and spot size.

23. The additive manufacturing machine according to claim 1, wherein several sources are focused on the same spot.

24. The additive manufacturing machine according to claim 1, wherein said sources are LEDs or Laser diodes.

25. The additive manufacturing machine according to claim 1, wherein the sources are arranged in rows and columns.

26. The additive manufacturing machine according to claim 25, wherein the rows and columns of the array of sources are arranged essentially obliquely relative to the direction of the mover defining the manufactured paths.

27. The additive manufacturing machine according to claim 1, further comprising a sensor for mapping the spot location and a microprocessor for analyzing inaccuracies and feeding back corrections to the mover or the actuator.

28. The additive manufacturing machine according to claim 1, wherein the mover is capable of moving in 3D.

29. A method for additive manufacturing, with the additive manufacturing machine according to claim 1, an object from additive manufacturing material on a working area, layer-after-layer in a plurality of layers, comprising:
actuating an array of focused illumination sources with spacing between the illumination sources in the array, wherein the illumination sources, when actuated, focus sufficient energy in each of an array of illumination spots to manufacture the additive manufacturing material in one of the layers of the additive manufacturing material at a time;
moving a mover, carrying the illumination sources or the working area, wherein, when the mover is actuated, the illumination spots form elongate manufactured paths in the one of the layers, with the paths having a width corresponding to a size of the spots; and
displacing the illumination spots within the one of the layers sideways relative to the paths over a smaller distance than the spacing.

30. A method for additive manufacturing, with the additive manufacturing machine according to claim 2, an object from additive manufacturing material on a working area, layer-after-layer in a plurality of layers comprising:
actuating an array of focused illumination sources, wherein the illumination sources, when actuated, focus sufficient energy in each of an array of illumination spots to manufacture the additive manufacturing material in one of the layers of the additive manufacturing material at a time;
moving a mover, carrying the illumination sources or the working area, wherein, when the mover is actuated, the illumination spots form elongate manufactured paths in the one of the layers, with the paths having a width corresponding to a size of the spots, wherein the array comprises at least two parallel rows of focused illumination sources with a spacing between the illumination sources in each row, wherein the rows are offset relative to each other in a staggered manner over a smaller distance than the spacing, and
obtaining printed paths formed by the illumination sources in one of the rows between paths formed by the illumination sources in at least one of the other rows.
